(19) United States
(12) Patent Application Publication
(10) Pub. No.: US 2025/0375671 A1
(43) Pub. Date: Dec. 11, 2025

(54) GOLF BALL MOLD AND GOLF BALL MANUFACTURING METHOD

(71) Applicant: Bridgestone Sports Co., Ltd., Tokyo (JP)

(72) Inventors: Katsunori SATO, Chichibushi (JP); Yusuke Tanaka, Chichibushi (JP)

(73) Assignee: Bridgestone Sports Co., Ltd., Tokyo (JP)

(21) Appl. No.: 19/224,970

(22) Filed: Jun. 2, 2025

(30) Foreign Application Priority Data
Jun. 11, 2024 (JP) 2024-094319

(51) Int. Cl. A63B 45/00; B29C 45/14; B29C 45/34; B29L 31/54

(52) U.S. Cl. CPC A63B 45/00; B29C 45/14073; B29C 45/14819; B29C 45/34; B29L 2031/546

(57) ABSTRACT

A vertically separating two-part golf ball mold having a spherical cavity, support pins and support pin holes for disposing a core in the cavity and vent pins and vent pin holes is designed so as to reduce flash formation, allow gases generated during molding to reliably escape to the exterior and enable golf balls having a good surface state to be obtained without lowering the ball durability.

### CROSS-REFERENCE TO RELATED APPLICATIONS

This non-provisional application claims priority under 35 U.S.C. § 119 (a) on Patent Application No. 2024-094319 filed in Japan on Jun. 11, 2024, the entire contents of which are hereby incorporated by reference.

### TECHNICAL FIELD

The present invention relates to a golf ball mold which can be suitably used for molding golf balls having a core encased by a cover of one, two or more layers, particularly for molding the outermost layer of a cover having numerous dimples formed on the surface. The invention also relates to a method for manufacturing golf balls using such a mold.

### BACKGROUND ART

Golf balls are typically manufactured by an injection molding or compression molding process. However, in both of these processes, production defects often arise during molding due to air remaining in the mold, air trapped in the molten resin or gases given off by the resin.

When the gases given off by the molten resin during the molding of a golf ball are poorly vented, this gives rise to “weld defects” (so-called weld-marks having a splayed shape like a bird's foot that form on the surface of the manufactured golf ball, resulting in a defective product). In addition, defects known as “burn marks” caused by the adiabatic compression of gases at the interior also arise. To prevent such defects, the clearances (gaps between pins and holes) for venting gases has been widened, allowing the gases to escape.

Yet, increasing the clearance between pins and their pin holes for venting gases allows relatively large flash to form on the surface of the golf ball, making it necessary to employ a thorough trimming step and thus substantially increasing production costs. In such cases, the ball's durability to cracking is also adversely affected.

In the prior art, JP-A 2012-130670, JP-A 2006-212910 and JP-A 2005-000346 disclose improvements in the shape and arrangement of support pins and vent pins aimed at facilitating the venting of gases. However, even the art described in this literature is unable to allow gases during molding to smoothly and reliably escape to the exterior and therefore cannot reliably and satisfactorily manufacture golf balls having a good surface state without lowering the durability of the ball.

### SUMMARY OF THE INVENTION

It is therefore an object of the invention to provide a golf ball mold having a cavity which reduces the formation of flashing, allows the smooth and reliable release of gases to the exterior during molding, and enables golf balls having a good surface state to be reliably obtained without lowering the durability of the ball.

As a result of intensive investigations, we have discovered that, in general, when a golf ball injection mold has support pins that hold a golf ball core in place and holes for those pins are present in the cavity, by adding vent pins for venting gases and thus increasing the number of places where gases are vented, the gap (clearance) between each support pin or vent pin and its pin hole can be made smaller, enabling the object of this invention to be achieved.

Accordingly, in a first aspect, the invention provides a vertically separating two-part golf ball mold having a spherical cavity, a plurality of support pins and support pin holes for disposing a core within the spherical cavity and one or more vent pin and vent pin hole, wherein the pin holes for the support pins have a clearance that allows gases generated within the spherical cavity during injection molding to be released to the exterior, the vent pins are located inward from where the support pins located outermost as seen from poles of the spherical cavity are positioned, the vent pin holes and support pin holes have a shortest distance therebetween of 0.20 mm or less, and the sum of the total area of the clearances between the vent pins and vent pin holes and the total area of the clearances between the support pins and support pin holes is 1.00 mm² or more.

In a preferred embodiment of the golf ball mold of the invention, each support pin is arranged at a position where the angle of intersection between an axis connecting top and bottom poles of the mold and a normal from a center on the axis and toward a wall of the cavity where the support pin retracts is between 15 and 30°.

In another preferred embodiment, the mold of the invention has three or more support pins in an upper mold half or a lower mold half.

In yet another preferred embodiment, the mold has three or more vent pins in an upper mold half or a lower mold half. At least one vent pin may be located at a pole.

In still another preferred embodiment, the number of vent pins is equal to or greater than the number of support pins.

In a further preferred embodiment, the clearance between the support pins and the support pin holes is 0.020 mm or less.

In a yet further preferred embodiment, the clearance between the vent pins and the vent pin holes is 0.020 mm or less.

In a still further preferred embodiment, the support pins slidably advance and retreat in the support pin holes and the vent pins do not move slidably.

In a second aspect, the invention provides a method for manufacturing golf balls having a single-layer or multilayer cover, which method includes the step of molding an outermost layer of the cover to a thickness of 1.5 mm or less using the golf ball mold of the first aspect of the invention.

### Advantageous Effects of the Invention

The golf ball mold of the invention and the inventive method for manufacturing golf balls using this mold reduce the formation of flashing, allow gases to be smoothly and reliably released to the exterior during molding, and enable golf balls having a good surface state to be reliably obtained without lowering the ball durability.

### BRIEF DESCRIPTION OF THE DRAWINGS

FIG. 1 is a schematic diagram showing a golf ball mold according to an embodiment of the invention.

FIG. 2 is a schematic diagram of the bottom half of the mold in FIG. 1, as seen from directly above.

FIG. 3 is a schematic cross-sectional diagram showing the positions of support pins arranged in the mold.

FIG. 4 is a schematic, explanatory diagram showing the distance between a support pin hole and a vent pin hole.

FIG. 5 shows plan views illustrating examples of support pin shapes and vent pin shapes, FIG. 5A being plan views in which the pin shapes have a straight neck and FIG. 5B being plan views in which the pin shapes have a tapered portion.

FIG. 6 shows schematic diagrams illustrating an example of a mechanism which slidably moves both the support pins and the vent pins, FIG. 6A being a schematic perspective view showing the mechanism and the mold body and FIG. 6B being a schematic cross-sectional view of the same.

FIG. 7 shows schematic diagrams illustrating an example of a mechanism which slidably moves both the support pins and the vent pins, FIG. 7A being a schematic perspective view showing the mechanism and the mold body and FIG. 7B being a schematic cross-sectional view of the same.

FIG. 8 shows schematic diagrams illustrating an example of a mechanism which slidably moves only the support pins and in which the vent pins are integrally united and remain stationary, with FIG. 8A being a schematic perspective view showing the mechanism and the mold body and FIG. 8B being a schematic cross-sectional view of the same.

FIG. 9 shows schematic diagrams illustrating an example of a mechanism which slidably moves only the support pins and in which the vent pins are integrally united and remain stationary, with FIG. 9A being a schematic perspective view showing the mechanism and the mold body and FIG. 9B being a schematic cross-sectional view of the same.

FIG. 10A is a plan view from above of the bottom half of the mold in Example 1, and FIG. 10B is a partially enlarged view showing the support pins and vent pins near the pole.

FIG. 11A is a plan view from above of the bottom half of the mold in Example 2, and FIG. 11B is a partially enlarged view showing the support pins and vent pins near the pole.

FIG. 12A is a plan view from above of the bottom half of the mold in Example 3, and

FIG. 12B is a partially enlarged view showing the support pins and vent pins near the pole.

FIG. 13A is a plan view from above of the bottom half of the mold in Comparative Example 1, and FIG. 13B is a partially enlarged view showing the support pins and vent pins near the pole.

FIG. 14A is a plan view from above of the bottom half of the mold in Comparative Example 2, and FIG. 14B is a partially enlarged view showing the support pins and vent pins near the pole.

FIG. 15A is a plan view from above of the bottom half of the mold in Comparative Example 3, and FIG. 15B is a partially enlarged view showing the support pins and vent pins near the pole.

### DETAILED DESCRIPTION OF THE INVENTION

The objects, features and advantages of the invention will become more apparent from the following detailed description taken in conjunction with the appended diagrams.

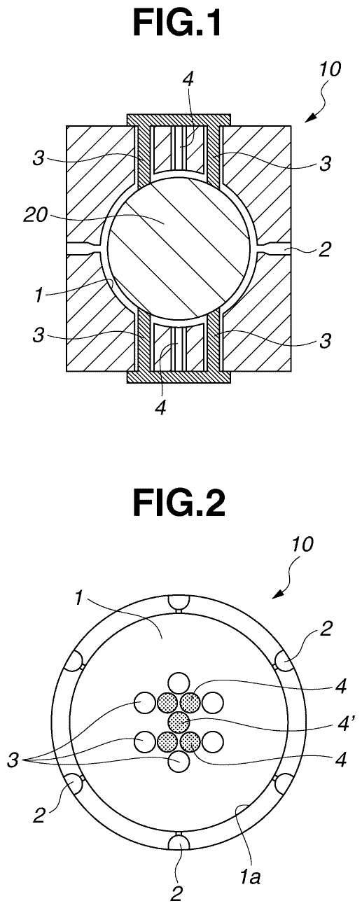

The golf ball mold of the invention has a spherical cavity, gates through which a cover-forming resin material flows into the spherical cavity, vent pins for venting gases, and support pins arranged so as to be able to advance and retreat in a direction orthogonal to the mold parting line. For example, FIG. 1, which is a schematic diagram of a mold interior prior to injection molding, shows an injection mold 10 that has a spherical cavity 1, a given number of gates 2 and given numbers of support pins 3 and vent pins 4. The mold 10 is used by having a molten resin material flow into the spherical cavity 1 from the gates 2 while a spherical insert 20 such as an intermediate layer-encased sphere is supported within the cavity 1 with support pins 3.

The support pins disposed so as to be able to advance and retreat in a direction perpendicular to the mold parting line are generally a plurality of support pins, preferably numbering three or more (e.g., three support pins at intervals of 120°), arranged at given intervals on a circle centered on the poles of the spherical cavity. The support pins have ends that may be circular or non-circular in shape. The endface of a support pin can constitute part of the cavity inside wall, and so the end of a support pin may be given a raised shape so as to form a dimple or may be shaped so as not to form a dimple. The support pins are generally arranged so as to be capable of advancing and retreating within support pin holes. As shown in FIG. 1, the support pins 3 move in such a way as to advance into the cavity 1, where they hold an intermediate layer-encased sphere 20 in place while a cover resin material fills the interior of the cavity 1, following which the support pins 3 are able to retreat to the position of an inside wall 1a of the cavity. To suppress deformation of the intermediate layer-encased sphere 20 that has been set within the cavity 1 as the resin material is filling the cavity interior and stably position the sphere 20 at the center of the cavity 1, it is desirable to optimize the diameter of the support pin ends and the number of support pins 3. As used herein, the diameter of a support pin end refers not to the diameter of a section cut perpendicular to the axis of the support pin, but rather to the diameter of the planar shape that follows the contour at the end of the support pin.

The number of support pins is preferably set to three or more, more preferably four or more, and even more preferably six or more, in each of the top and bottom halves of the mold. The upper limit of this number is preferably 12 or less, more preferably 10 or less, and even more preferably 9 or less. Outside of this range, it is sometimes difficult to suppress deformation of the intermediate layer-encased sphere and form the cover-forming resin material to a uniform thickness throughout the space between the intermediate layer-encased sphere and the cavity wall while holding the intermediate layer-encased sphere at the center of the cavity.

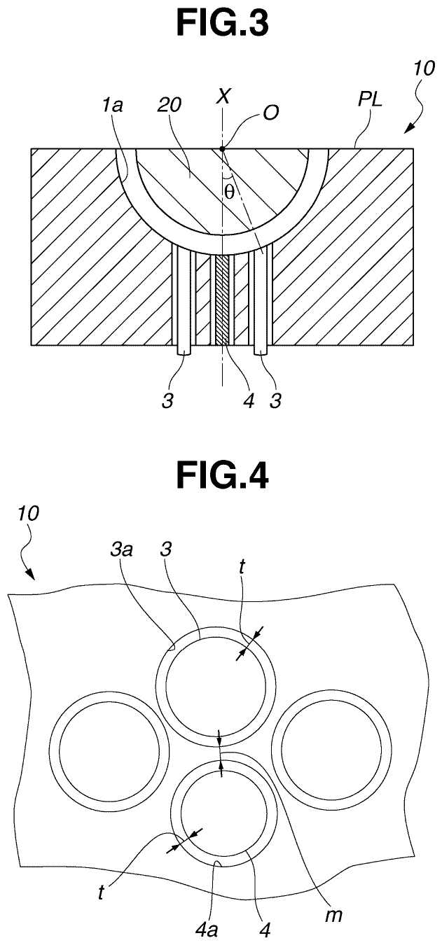

Regarding the positions of the support pins 3, referring to FIG. 3, it is desirable for each support pin 3 to be arranged at a position where the angle of intersection θ between an axis X connecting top and bottom poles of the mold 10 and a normal from a center O on the axis and toward the cavity wall 1a where the support pin 3 retreats to be between 15° and 30°. This angle is more preferably 16° or more, and even more preferably 17° or more. The upper limit is preferably 30° or less, more preferably 28° or less, and even more preferably 25° or less. Outside of this range in the angle, it is sometimes difficult to suppress deformation of the intermediate layer-encased sphere 20 and form the cover-forming resin material to a uniform thickness throughout the space between the intermediate layer-encased sphere 20 and the cavity wall 1a while holding the intermediate layer-encased sphere 20 at the center O of the cavity.

The vent pins 4 are located inward (i.e., on the pole side) from, of the support pins 3, those support pins 3 having the largest angle θ, and are preferably arranged so as to be surrounded by a plurality of support pins 3. It is preferable for at least one vent pin 4 to be located at the pole; that is, to be a center pin. Referring to FIG. 2, which is a plan view of the bottom half of the mold 10 in FIG. 1, six support pins 3 are arranged on the wall of the spherical cavity 1 so as to be spaced apart at given intervals around the pole, and five vent pins 4 are arranged inwards (on the pole side) of these support pins 3. Of these, one vent pin (a center pin) 4′ is located at the pole.

The number of vent pins is not particularly limited so long as there is one vent pin in the upper mold half or the lower mold half, although three or more vent pins are preferred. The number of vent pins is more preferably equal to or greater than the number of support pins.

The vent pins have ends that, as with the ends of the support pins, may be circular or non-circular in shape. The endface of a vent pin can constitute part of the cavity inside wall, and so the end of a vent pin may be given a raised shape so as to form a dimple or may be shaped so as not to form a dimple.

It is desirable for the clearance of each support pin and vent pin (i.e., the gap between the pin and its pin hole) to be as small as possible. Specifically, referring to FIG. 4, the gap (clearance) t between a support pin 3 and its pin hole 3a is preferably 0.020 mm or less, and more preferably 0.015 mm or less. In the case of the vent pins, similarly, the gap (clearance) t between a vent pin 4 and its pin hole 4a is preferably 0.020 mm or less, and more preferably 0.015 mm or less.

Also, it is critical for the distance between the support pins and the vent pins, i.e., the shortest distance between the pin holes of the respective pins (closest distance between pin hole contours) to be small. Specifically, referring to FIG. 4, an arrangement in which the shortest distance m between the pin hole 3a of a support pin 3 and the pin hole 4a of a vent pin 4 is 0.20 mm or less, preferably 0.15 mm or less, exists at one or more place. By thus setting this shortest distance to 0.20 mm or less, it is possible to efficiently discharge gases that are generated outside of the mold.

The sum of the total area of the clearances between the vent pins and their pin holes and the total area of the clearances between the support pins and their pin holes must be 1.00 mm² or more, and is preferably 1.05 mm² or more. At a total area for the above clearances of less than 1.00 mm², the absolute amount of space overall where gas is discharged becomes insufficient, gas buildup occurs, and the formation of weld marks increases.

A plurality of gates are formed along a parting line of the mold. In the embodiment shown in FIG. 2, six gates 2 are uniformly arranged along the parting line PL. In order to have the molten resin material circulate uniformly within the spherical cavity 1 and form a cover of the desired thickness, the gates 2 are preferably arranged at equal intervals on the periphery of the parting line PL.

A composite plating film may be formed in the spherical cavity of the mold in such a way as to cover the cavity surface. The material (substrate) making up the mold body is not particularly limited, so long as it is a plateable metal. For example a mold formed of a typical metal material such as carbon steel, beryllium-copper alloy, stainless steel or copper may be used. Of these, it is preferable to use prehardened steel that has been heat-treated beforehand. Because prehardened steel has an excellent workability and, moreover, does not require subsequent heat treatment to be carried out, complex dimple shapes can be precisely created. The composite plating film is not particularly limited. For example, a material obtained by dispersing fluorocarbon resin particles in a nickel matrix may be used.

The support pin and vent pin material is not particularly limited. For example, prehardened steel, stainless steel or die steel may be chiefly used.

The support pins can slide together during injection molding. On the other hand, either a sliding or a stationary arrangement may be employed for the vent pins. Alternatively, an arrangement may be employed in which the support pins and the vent pins all slide collectively in unison.

The support pins and the vent pins may both have a straight-necked shape, or a tapered pin shape in which the thickness of the pin neck gradually varies may be used to facilitate gas discharge. A center pin is located at or near a golf ball pole during injection molding, this being one type of vent pin. The center pin may have a straight-necked shape, or a tapered pin shape may be used.

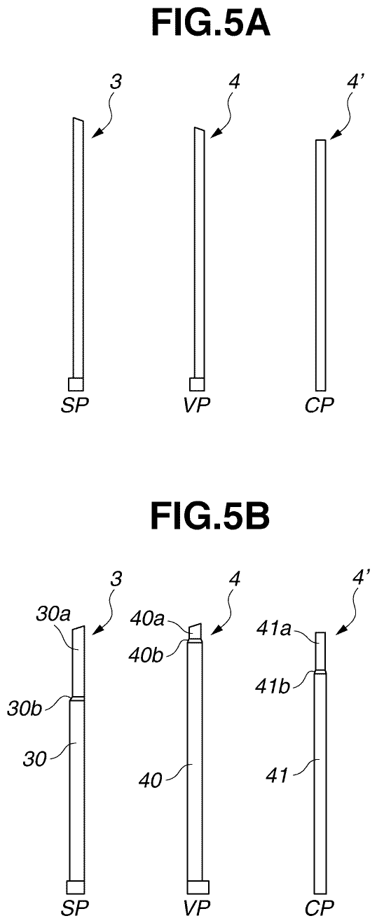

For example, in FIG. 5A, a support pin (SP) 3, a vent pin (VP) 4 and a center pin (CP) 4′ each exhibit a straight-necked shape without a varying shape such as a taper. On the other hand, the support pin (SP) 3 in FIG. 5B has an end portion 30a which is shaped such as to be of smaller diameter than the support pin body 30 owing to a tapered portion 30b and to have a shaft that projects upward a long way. The vent pin (VP) 4 has an end portion 40a which is shaped such as to be of a diameter that is slightly smaller than the vent pin body 40 owing to a tapered portion 40b. The center pin (CP) 4′ has an end portion 41a which is shaped such as to be of a smaller diameter than the center pin body 41 owing to a tapered portion 41b and to have a shaft that projects upward for some way.

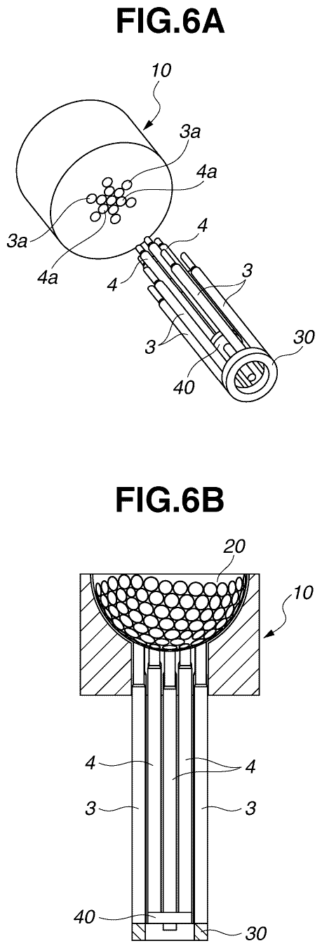

FIGS. 6 to 9 are schematic diagrams showing, as modes of the invention, exemplary mechanisms in which support pins and vent pins having the above-described shapes are combined and all the pins are caused to move slidably, and exemplary mechanisms in which the vent pins remain stationary and only the support pins are caused to move slidably.

FIG. 6 shows a mechanism which slidably moves all the support pins and vent pins, FIG. 6A being a schematic perspective view showing the mechanism and the mold body and FIG. 6B being a schematic cross-sectional view of the same. In FIG. 6, support pins 3 and vent pins 4 all integrally slide with movement of a support pin base 30, a vent pin base 40 and a single center pin. Each support pin 3 and vent pin 4 has a tapered portion.

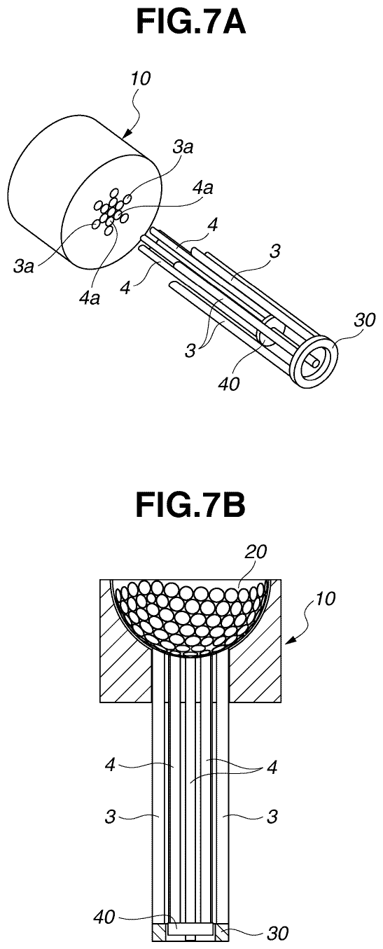

FIG. 7, like FIG. 6, shows a mechanism which slidably moves all the support pins and vent pins, FIG. 7A being a schematic perspective view showing the mechanism and the mold body and FIG. 7B being a schematic cross-sectional view of the same. The support pins 3 and vent pins 4 all integrally slide with movement of a support pin base 30, a vent pin base 40 and a single center pin. In FIG. 7, each support pin 3 and vent pin 4 exhibits a straight-necked shape without a tapered portion.

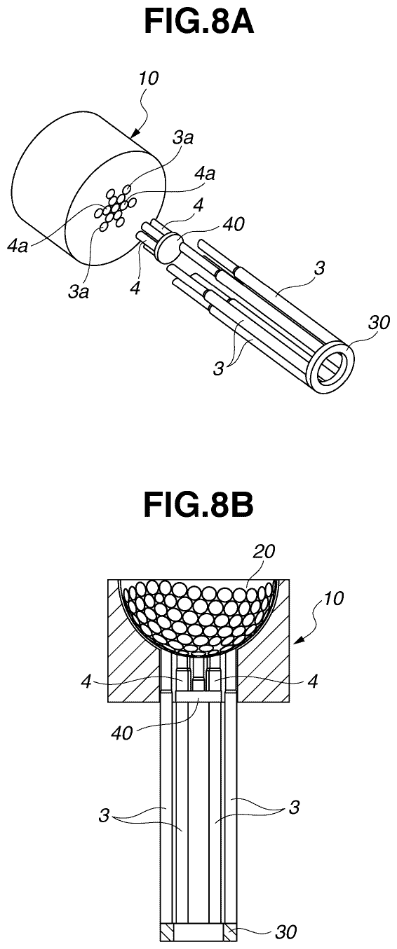

FIG. 8 shows a mechanism which slidably moves only the support pins and in which the vent pins are integrally united and remain stationary, FIG. 8A being a schematic perspective view showing the mechanism and the mold body and FIG. 8B being a schematic cross-sectional view of the same. As shown in FIG. 8B, the vent pin mechanism has a monolithic structure in which a plurality of vent pins 4 are integrally united on a vent pin base 40 and is fixed in place within the mold. The plurality of support pins 3 integrally slide with movement of the support pin base 30. In FIG. 8, each support pin 3 and vent pin 4 has a tapered portion.

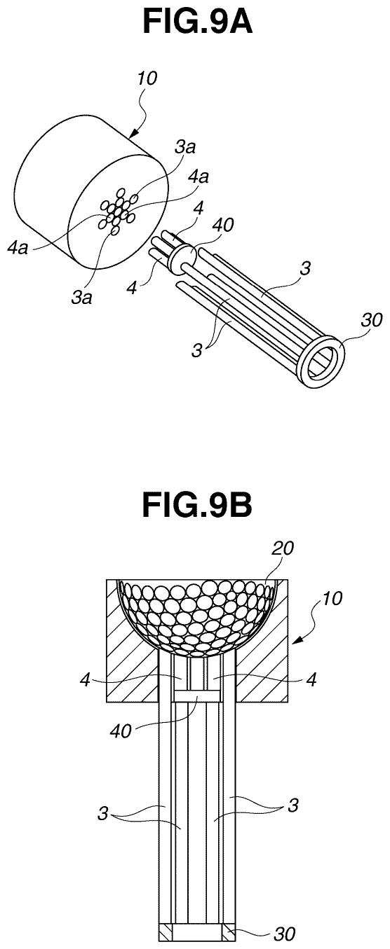

FIG. 9, like FIG. 8, shows a mechanism which slidably moves only the support pins and in which the vent pins are integrally united and remain stationary, FIG. 9A being a schematic perspective view showing the mechanism and the mold body and FIG. 9B being a schematic cross-sectional view of the same. The vent pin mechanism has a monolithic structure in which a plurality of vent pins 4 are integrally united on a vent pin base 40 and is fixed in place within the mold. The plurality of support pins 3 integrally slide with movement of the support pin base 30. In FIG. 9, each support pin 3 and vent pin 4 exhibits a straight-necked shape without a tapered portion.

In the golf ball mold of the invention, numerous dimple-forming projections are formed on the wall of the spherical cavity. During injection molding of the golf ball cover material, numerous dimples are formed at the same time as the cover by way of these dimple-forming projections. The dimples may be arranged on the ball's surface in the form of a polyhedron such as an icosahedron, dodecahedron or octahedron, or with rotational symmetry about the ball axis, such as three-fold symmetry or five-fold symmetry.

To fabricate the golf ball mold of the invention, a technique may be employed in which 3D CAD/CAM is used to directly cut the entire surface shape three-dimensionally into a master mold from which the golf ball mold is subsequently made by pattern reversal, or to directly cut the cavity of the mold three-dimensionally.

The present invention also provides a method for manufacturing golf balls which includes the step of producing the above cover using the above-described golf ball mold. In this case, the golf ball to be manufactured is not particularly limited as to the ball type or construction, so long it has a core and a single-layer or multilayer cover. When molding a cover using the golf ball mold of the invention, to fully manifest the desired working effects of the invention, it is best to mold the outermost layer of the cover to a thickness of preferably 1.5 mm or less, and more preferably 1.4 mm or less.

### EXAMPLES

The following Examples and Comparative Examples are provided to illustrate the invention, and are not intended to limit the scope thereof.

### Examples 1 to 3, Comparative Examples 1 to 3

The molds in Examples 1 to 3 and Comparative Examples 1 to 3 were used to injection-mold in each case a cover (outermost layer) over a sphere composed of a core and an intermediate layer enveloping the core (intermediate layer-encased sphere). The details are shown in Table 1. The core was formed of a rubber composition composed primarily of polybutadiene, and the intermediate layer was formed of a resin material composed primarily of an ionomer resin.

The types of cover (outermost layer) were as follows.

In the case of two-piece golf balls, the cover material was a resin material composed primarily of ionomer resin and having a Shore D hardness of 62.

In the case of three-piece golf balls, the cover material was a resin material composed primarily of polyurethane and having a Shore D hardness of 43.

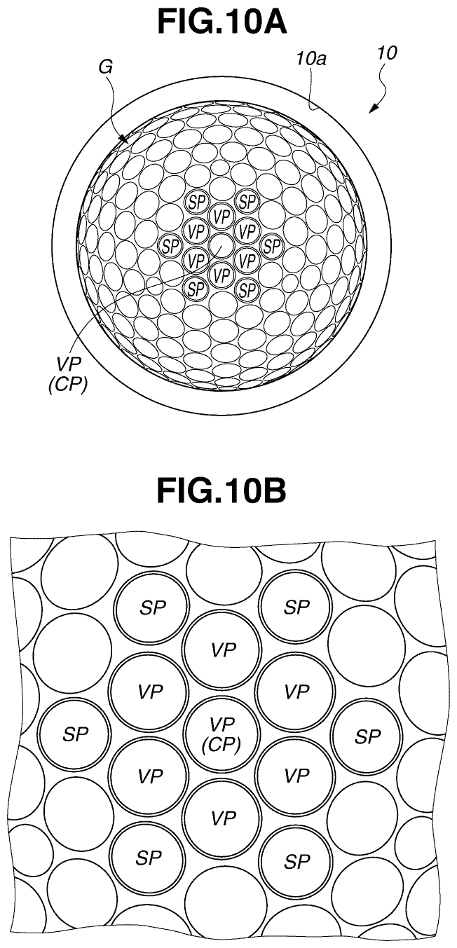

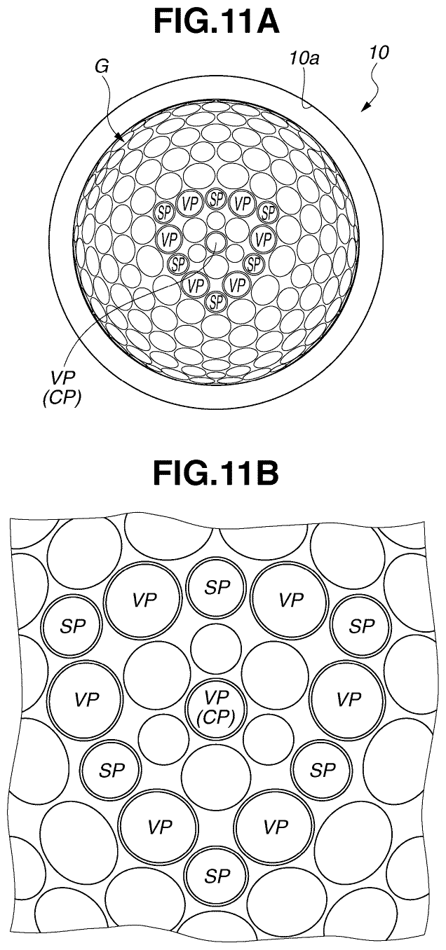

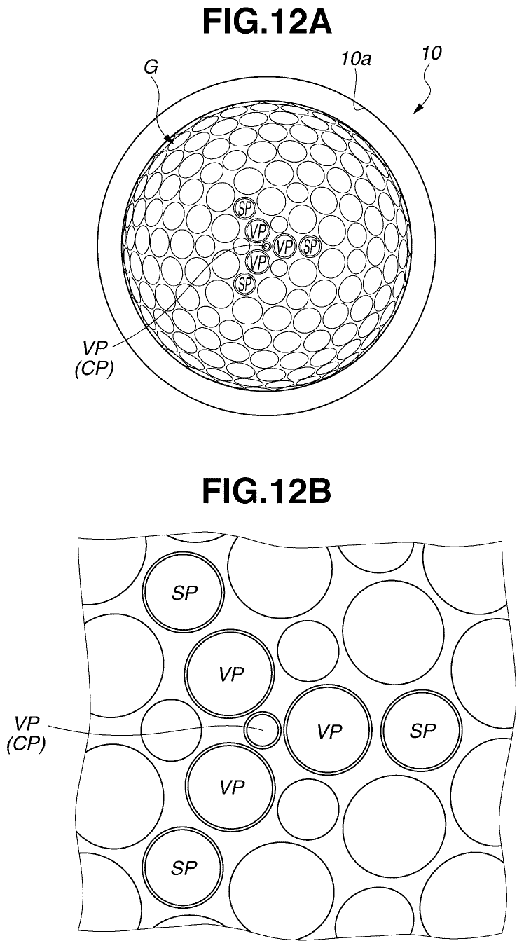

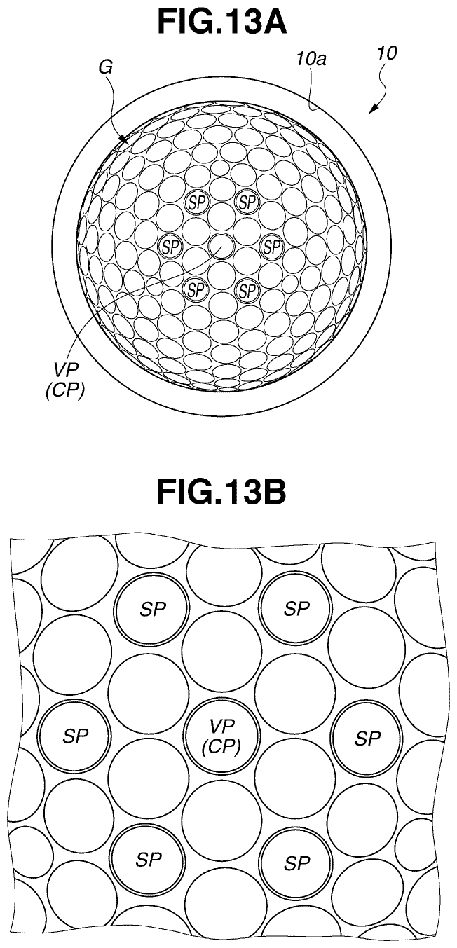

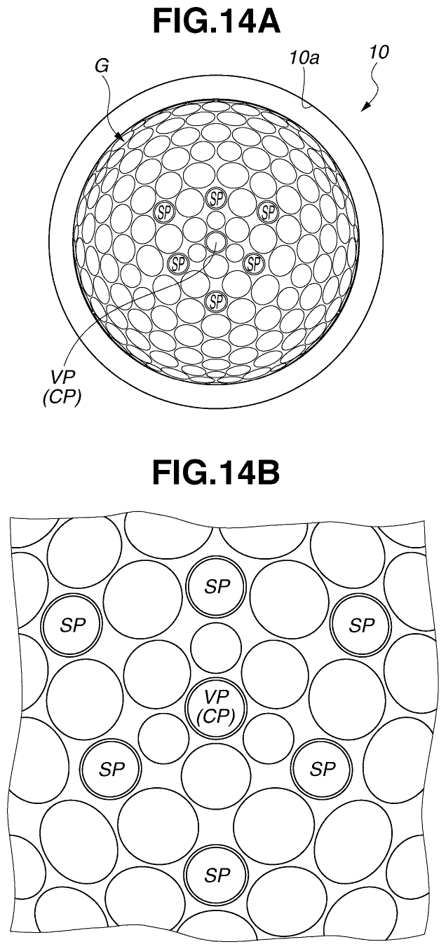

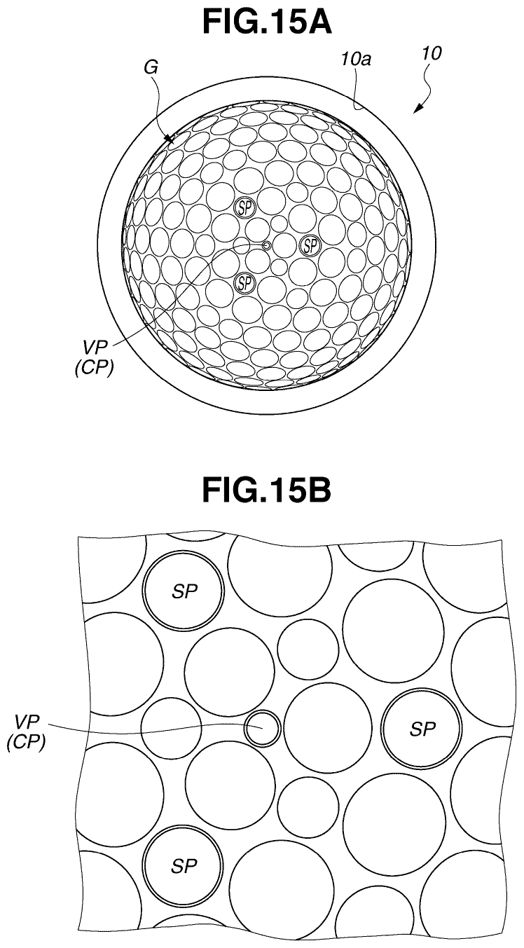

The positions of the support pins and vent pins disposed in the molds used in the respective examples are shown in FIG. 10 (Example 1), FIG. 11 (Example 2), FIG. 12 (Example 3), FIG. 13 (Comparative Example 1), FIG. 14 (Comparative Example 2) and FIG. 15 (Comparative Example 3). FIGS. 10A, 11A, 12A, 13A, 14A and 15A are plan views from above of the bottom half of the mold, and FIGS. 10B, 11B, 12B, 13B, 14B and 15B are partially enlarged views showing the support pins and vent pins near the pole. Table 1 shows the locations of these pins within the respective diagrams in terms of latitude and longitude, with the latitude at the pole of the spherical cavity being set to 0 degrees and the latitude at the seam plane being set to 90 degrees.

Three dimple configurations were used in the examples: Type 1, Type 2 and Type 3. The dimple configurations formed on the wall of the cavity in the bottom mold half are shown in FIGS. 10 (Example 1) to 15 (Comparative Example 3).

The clearance between a support pin or vent pin and its pin hole is indicated by the symbol ‘t’ in FIG. 4. The distance between a support pin hole and a vent pin hole is indicated by the symbol ‘m’.

The support pins gradually retreat by sliding back as the molten resin material fills the spherical cavity, with movement stopping when filling of the cavity by the molten resin material is complete. When the support pins are fully retracted, their endfaces are either flush with the cavity wall or project out from the cavity wall in such a way as to form dimples. Similarly, in cases where the vent pins move slidably, when fully retracted their endfaces are either flush with the cavity wall or project out from the cavity wall in such a way as to form dimples. The vent pins may be designed to move slidably in the same way as the support pins or may remain stationary, although in these examples according to the invention, the vent pins remain stationary and do not move slidably.

Golf balls were manufactured by using the molds in the respective examples to injection-mold the covers. The durability to cracking of the resulting golf balls was evaluated as described below. Those results are shown in Table 1.

### [Durability to Cracking on Repeated Impact]

The durability of the ball was evaluated using the ADC Ball COR Durability Tester manufactured by Automated Design Corporation (U.S.). This tester fires a golf ball pneumatically, causing it to consecutively strike two metal plates arranged in parallel. The average of the number of shots required for the golf ball to crack is treated as the durability. Here, the average is the value arrived at by furnishing ten balls of the same type for testing and averaging the number of shots required for each of the ten balls to crack when fired. The type of tester was a horizontal COR, and the incident velocity against the metal plates was set to 43 m/s.

### Evaluation Criteria:

Good: Average is 150 times or more
Fair: Average is at least 130 times and up to 149 times
Poor: Average is 129 times or less

TABLE 1

| | | Example 1 | | | Example 2 | | | Example 3 | | |
|---|---|---|---|---|---|---|---|---|---|---|
| | | | | CP | | | CP | | | CP |
| | | SP | VP | (VP) | SP | VP | (VP) | SP | VP | (VP) |
| Pin area/ | Number (N) | 6 | 6 | 1 | 6 | 6 | 1 | 3 | 3 | 1 |
| distance | Pin hole diameter (mm) | 4.030 | 4.330 | 4.030 | 3.430 | 4.430 | 3.430 | 3.430 | 3.830 | 1.530 |
| | Pin diameter (mm) | 4.000 | 4.300 | 4.000 | 3.400 | 4.400 | 3.400 | 3.400 | 3.800 | 1.500 |
| | Clearance (mm) | 0.015 | 0.015 | 0.015 | 0.015 | 0.015 | 0.015 | 0.015 | 0.015 | 0.015 |
| | Clearance area (mm²) | 0.189 | 0.203 | 0.189 | 0.161 | 0.208 | 0.161 | 0.161 | 0.180 | 0.071 |
| | Clearance area × N | 1.135 | 1.220 | 0.189 | 0.966 | 1.248 | 0.161 | 0.483 | 0.539 | 0.071 |
| | (mm²) | | | | | | | | | |
| | Total clearance area | 2.544 | | | 2.375 | | | 1.094 | | |
| | (mm²) | | | | | | | | | |
| | Shortest distance between | 0.05 | | | 0.15 | | | 0.19 | | |
| | support pin hole and | | | | | | | | | |
| | vent pin hole (mm) | | | | | | | | | |
| | | No. | Latitude | Longitude | No. | Latitude | Longitude | No. | Latitude | Longitude |
| Support pin | Support pin coordinates | \textcircled{1} | 20.7 | 330 | \textcircled{1} | 17.5 | 300 | \textcircled{1} | 17.5 | 300 |
| positions | (pole: 0° latitude) | \textcircled{1} | 20.7 | 270 | \textcircled{1} | 17.5 | 180 | \textcircled{1} | 17.5 | 180 |
| | (equator: 90° latitude) | \textcircled{1} | 20.7 | 210 | \textcircled{1} | 17.5 | 60 | \textcircled{1} | 17.5 | 60 |
| | | \textcircled{1} | 20.7 | 150 | \textcircled{2} | 25.0 | 240 | | | |
| | | \textcircled{1} | 20.7 | 90 | \textcircled{2} | 25.0 | 120 | | | |
| | | \textcircled{1} | 20.7 | 30 | \textcircled{2} | 25.0 | 0 | | | |
| Vent pin | Vent pin coordinates | \textcircled{1} | 11.9 | 300 | \textcircled{1} | 19.4 | 25.5 | \textcircled{1} | 7.0 | 300 |
| positions | (pole: 0° latitude) | \textcircled{1} | 11.9 | 180 | \textcircled{1} | 19.4 | 334.5 | \textcircled{1} | 7.0 | 180 |
| | (equator: 90° latitude) | \textcircled{1} | 11.9 | 60 | \textcircled{1} | 19.4 | 265.5 | \textcircled{1} | 7.0 | 60 |
| | | \textcircled{2} | 12.1 | 240 | \textcircled{1} | 19.4 | 214.5 | Center | 0 | 0 |
| | | \textcircled{2} | 12.1 | 120 | \textcircled{1} | 19.4 | 145.5 | | | |
| | | \textcircled{2} | 12.1 | 0 | \textcircled{1} | 19.4 | 94.5 | | | |
| | | Center | 0 | 0 | Center | 0 | 0 | | | |
| Dimples | Configuration | Type 1 | | | Type 2 | | | Type 3 | | |
| | Number | 338 | | | 344 | | | 330 | | |
| Ball | Cover thickness (mm) | 1.4 | | | 1.5 | | | 1.35 | | |
| construction | Durability on impact | 153 | | | 166 | | | 156 | | |
| (2-piece) | (number of shots) | | | | | | | | | |
| | Durability rating | Good | | | Good | | | Good | | |
| Ball | Cover thickness (mm) | 0.8 | | | 1.0 | | | 1.2 | | |
| construction | Durability on impact | 165 | | | 171 | | | 187 | | |
| (3-piece) | (number of shots) | | | | | | | | | |
| | Durability rating | Good | | | Good | | | Good | | |
| | | Comparative Example 1 | | | Comparative Example 2 | | | Comparative Example 3 | | |
| | | | | CP | | | CP | | | CP |
| | | SP | VP | (VP) | SP | VP | (VP) | SP | VP | (VP) |
| Pin area/ | Number (N) | 6 | 0 | 1 | 6 | 0 | 1 | 3 | 0 | 1 |
| distance | Pin hole diameter (mm) | 4.040 | — | 4.040 | 3.440 | — | 3.440 | 3.450 | — | 1.550 |
| | Pin diameter (mm) | 4.000 | — | 4.000 | 3.400 | — | 3.400 | 3.400 | — | 1.500 |
| | Clearance (mm) | 0.020 | — | 0.020 | 0.020 | — | 0.020 | 0.025 | — | 0.025 |
| | Clearance area (mm²) | 0.253 | — | 0.253 | 0.215 | — | 0.215 | 0.269 | — | 0.120 |
| | Clearance area × N | 1.516 | — | 0.253 | 1.289 | — | 0.215 | 0.807 | — | 0.120 |
| | (mm²) | | | | | | | | | |
| | Total clearance area | 1.768 | | | 1.504 | | | 0.927 | | |
| | (mm²) | | | | | | | | | |
| | Shortest distance between | 4.00 | | | 3.00 | | | 3.80 | | |
| | support pin hole and | | | | | | | | | |
| | vent pin hole (mm) | | | | | | | | | |
| | | No. | Latitude | Longitude | No. | Latitude | Longitude | No. | Latitude | Longitude |
| Support pin | Support pin coordinates | \textcircled{1} | 20.7 | 330 | \textcircled{1} | 17.5 | 300 | \textcircled{1} | 17.5 | 300 |
| positions | (pole: 0° latitude) | \textcircled{1} | 20.7 | 270 | \textcircled{1} | 17.5 | 180 | \textcircled{1} | 17.5 | 180 |
| | (equator: 90° latitude) | \textcircled{1} | 20.7 | 210 | \textcircled{1} | 17.5 | 60 | \textcircled{1} | 17.5 | 60 |
| | | \textcircled{1} | 20.7 | 150 | \textcircled{2} | 25.0 | 240 | | | |
| | | \textcircled{1} | 20.7 | 90 | \textcircled{2} | 25.0 | 120 | | | |
| | | \textcircled{1} | 20.7 | 30 | \textcircled{2} | 25.0 | 0 | | | |
| Vent pin | Vent pin coordinates | Center | 0 | 0 | Center | 0 | 0 | Center | 0 | 0 |
| positions | (pole: 0° latitude) | | | | | | | | | |
| | (equator: 90° latitude) | | | | | | | | | |
| Dimples | Configuration | Type 1 | | | Type 2 | | | Type 3 | | |
| | Number | 338 | | | 344 | | | 330 | | |
| Ball | Cover thickness (mm) | 1.4 | | | 1.5 | | | 1.35 | | |
| construction | Durability on impact | 131 | | | 137 | | | 106 | | |
| (2-piece) | (number of shots) | | | | | | | | | |
| | Durability rating | Fair | | | Fair | | | Poor | | |
| Ball | Cover thickness (mm) | 0.8 | | | 1.0 | | | 1.2 | | |
| construction | Durability on impact | 134 | | | 146 | | | 118 | | |
| (3-piece) | (number of shots) | | | | | | | | | |

| | | | |
|---|---|---|---|
| Durability rating | Fair | Fair | Poor |

SP: support pin
VP: vent pin
CP: center pin

Japanese Patent Application No. 2024-094319 is incorporated herein by reference. Although some preferred embodiments have been described, many modifications and variations may be made thereto in light of the above teachings. It is therefore to be understood that the invention may be practiced otherwise than as specifically described without departing from the scope of the appended claims.

1. A vertically separating two-part golf ball mold comprising a spherical cavity, a plurality of support pins and support pin holes for disposing a core within the spherical cavity and one or more vent pin and vent pin hole, wherein the pin holes for the support pins have a clearance that allows gases generated within the spherical cavity during injection molding to be released to the exterior, the vent pins are located inward from where the support pins located outermost as seen from poles of the spherical cavity are positioned, the vent pin holes and support pin holes have a shortest distance therebetween of 0.20 mm or less, and the sum of the total area of the clearances between the vent pins and vent pin holes and the total area of the clearances between the support pins and support pin holes is 1.00 mm² or more.

2. The mold of claim 1, wherein each support pin is arranged at a position where the angle of intersection between an axis connecting top and bottom poles of the mold and a normal from a center on the axis and toward a wall of the cavity where the support pin retracts is between 15 and 30°.

3. The mold of claim 1, wherein the mold has three or more support pins in an upper mold half or a lower mold half.

4. The mold of claim 1, wherein the mold has three or more vent pins in an upper mold half or a lower mold half.

5. The mold of claim 4, wherein at least one vent pin is located at a pole.

6. The mold of claim 1, wherein the number of vent pins is equal to or greater than the number of support pins.

7. The mold of claim 1, wherein the clearance between the support pins and the support pin holes is 0.020 mm or less.

8. The mold of claim 1, wherein the clearance between the vent pins and the vent pin holes is 0.020 mm or less.

9. The mold of claim 1, wherein the support pins slidably advance and retreat in the support pin holes and the vent pins do not move slidably.

10. A method for manufacturing golf balls having a single-layer or multilayer cover, which method comprises the step of molding an outermost layer of the cover to a thickness of 1.5 mm or less using the golf ball mold of claim 1.
